(19) United States
(12) Patent Application Publication
(10) Pub. No.: US 2025/0224666 A1
(43) Pub. Date: Jul. 10, 2025

(54) METHOD FOR OPTIMIZING OPTICAL PROXIMITY CORRECTION MODEL AND METHOD FOR MANUFACTURING SEMICONDUCTOR DEVICE INCLUDING THE SAME

(71) Applicant: SAMSUNG ELECTRONICS CO., LTD., SUWON-SI (KR)

(72) Inventors: Min-Cheol KANG, Suwon-si (KR); Dong Hoon KUK, Suwon-si (KR)

(21) Appl. No.: 18/804,242

(22) Filed: Aug. 14, 2024

(30) Foreign Application Priority Data
Jan. 5, 2024 (KR) 10-2024-0001910

(51) Int. Cl. G03F 1/36; G03F 1/70; G03F 1/86; G06F 30/27; G06F 111/06; G06F 119/18

(52) U.S. Cl. CPC G03F 1/36; G03F 1/70; G03F 1/86; G06F 30/27; G06F 2111/06; G06F 2119/18

(57) ABSTRACT

The method comprises preparing candidate chromosomes representing candidate solutions, and each of the candidate chromosomes includes a plurality of genes. The method further includes classifying the candidate chromosomes into a plurality of population groups, each of which follows a Gaussian distribution, and calculating a fitness value for each of the candidate chromosomes. The method additionally includes determining whether the genetic algorithm ends on the basis of the calculated fitness value, selecting a parent chromosome among the candidate chromosomes, when the genetic algorithm does not end, and generating offspring chromosomes from the parent chromosome. Genes of the offspring chromosomes follow the Gaussian distribution of the population group to which the parent chromosome belongs. The method also includes classifying the generated offspring chromosomes into the plurality of population groups.

### CROSS-REFERENCE TO RELATED APPLICATION

This application claims priority under 35 USC § 119 to Korean Patent Application No. 10-2024-0001910, filed on Jan. 5, 2024 in the Korean Intellectual Property Office, the disclosure of which is incorporated by reference herein in its entirety.

### TECHNICAL FIELD

The present inventive concept relates to a method for optimizing an optical proximity correction model and a method for manufacturing a semiconductor device using the same, and more specifically, to a method for optimizing parameters of an optical proximity correction model using a stochastic genomic algorithm (SGA).

### DISCUSSION OF THE RELATED ART

Semiconductor devices have become increasingly useful in the electronic industry due to their characteristics such as a miniaturization, a multi-functionality, and/or a low manufacturing cost. For example, semiconductor devices may be classified into semiconductor memory devices that store logic data, semiconductor logic devices that perform arithmetic processing on the logic data, hybrid semiconductor devices that include a memory element and a logic element, and the like. As the electronic industry increasingly develops, the demand for semiconductor devices having increased miniaturization, multi-functionality, and/or a low manufacturing cost are gradually increasing. For example, demand for high reliability, high speed, and/or multi-functionality of the semiconductor devices are gradually increasing. To satisfy such characteristics, the internal structures of the semiconductor devices are becoming increasingly complex, and the semiconductor devices are becoming increasingly integrated.

In general, patterns of a semiconductor chip are formed by a photolithography process and an etching process. When circuit patterns on a mask are transferred onto a substrate through the photolithography process to form a circuit pattern on the substrate (hereinafter referred to as a “transferred circuit pattern”), a gap occurs between the transferred circuit pattern on the substrate and an actually designed circuit pattern. Such a gap is caused by the optical proximity effect in the photolithography process. To accurately transfer the circuit pattern on the mask onto the substrate, an optical proximity correction (OPC) method is mainly used in the photolithography process. A model-based OPC is a way of correcting the circuit pattern of a mask by applying one model to full chips on the substrate. As the degree of integration of semiconductor devices increases and semiconductor processes become finer, the number of patterns included in the semiconductor layout increases. Therefore, in response to the increasing amount of computation for correcting or changing the layout of patterns to compensate for process errors, a method for optimizing the optical proximity correction model is under development.

### SUMMARY

According to an embodiment of the present inventive concept, a method for optimizing an optical proximity correction model includes: acquiring a SEM image, which is an average image of a plurality of images, and a GDS image, which is an image of a designed layout; aligning the SEM image and the GDS image with each other; performing image filtering on the SEM image; extracting a contour from the SEM image; and optimizing the optical proximity correction model by verifying the contour, wherein the optimization of the optical proximity correction model is performed by a genetic algorithm; preparing candidate chromosomes representing candidate solutions, wherein each of the candidate chromosomes includes a plurality of genes; classifying the candidate chromosomes into a plurality of population groups, each of which follows a Gaussian distribution; calculating a fitness value for each of the candidate chromosomes; determining whether the genetic algorithm ends on the basis of the calculated fitness value; selecting a parent chromosome among the candidate chromosomes, when the genetic algorithm does not end; generating offspring chromosomes from the parent chromosome, wherein genes of the offspring chromosomes follow the Gaussian distribution of the population group to which the parent chromosome belongs; and classifying the generated offspring chromosomes into the plurality of population groups.

According to an embodiment of the present inventive concept, a method for manufacturing a semiconductor device includes: designing a layout; performing an optical proximity correction on the designed layout; and forming photoresist patterns on a substrate, by using a photolithography process that uses a photomask that is manufactured with a corrected layout generated from the optical proximity correction, wherein performing the optical proximity correction includes: forming an optical proximity correction model; correcting the optical proximity correction model depending on simulation results on the optical proximity correction model; and verifying the corrected optical proximity correction model, wherein forming the optical proximity correction model includes optimizing the optical proximity correction model by using a genetic algorithm, and wherein optimizing the optical proximity correction model includes: preparing candidate chromosomes representing candidate solutions, wherein each of the candidate chromosomes includes a plurality of genes; classifying the candidate chromosomes into a plurality of population groups, each of which follows a Gaussian distribution; calculating a fitness value for each of the candidate chromosomes; determining whether the genetic algorithm ends on the basis of the calculated fitness value; selecting a parent chromosome among the candidate chromosomes, when the genetic algorithm does not end; generating offspring chromosomes from the parent chromosome, wherein genes of the offspring chromosomes follow the Gaussian distribution of a population group to which the parent chromosome belongs; and classifying the generated offspring chromosomes into the plurality of population groups.

According to an embodiment of the present inventive concept, a computing system includes: a processor; and a memory which stores instructions, wherein when executed by the processor, the instructions cause the processor to perform operations including, by using a genetic algorithm: preparing candidate chromosomes representing candidate solutions, wherein each of the candidate chromosomes includes a plurality of genes; classifying the candidate chromosomes into a plurality of population groups each of which follows a Gaussian distribution; calculating a fitness value for each of the candidate chromosomes; generating a rank value on the basis of the calculated fitness value; determining whether a genetic algorithm ends on the calculated fitness value; selecting a parent chromosome among the candidate chromosomes when the genetic algorithm does not end; generating offspring chromosomes from the parent chromosome, in which the genes of the offspring chromosomes follow a Gaussian distribution of a population group to which the parent chromosome belongs; determining whether the fitness value change is saturated; adjusting a configuration of the plurality of population groups when the fitness value change is saturated; and classifying the generated offspring chromosomes into the plurality of population groups.

### BRIEF DESCRIPTION OF THE DRAWINGS

The above and other aspects and features of the present inventive concept will become more apparent by describing in detail example embodiments thereof with reference to the attached drawings, in which:

FIG. 1 is a block diagram illustrating a computing system for performing a semiconductor design according to an embodiment of the present inventive concept;

FIG. 2 is a flowchart of a method for designing and manufacturing a semiconductor device according to the embodiment of the present inventive concept;

FIG. 3 is a conceptual diagram illustrating a photolithography system which uses a photomask manufactured according to an embodiment of the present inventive concept;

FIG. 4 shows an example of a photomask included in the photolithography system of FIG. 3;

FIG. 5 shows a circuit pattern printed on a substrate by the use of the photomask of FIG. 4;

FIG. 6 is a flowchart showing a step of performing the optical proximity correction procedure of FIG. 2;

FIG. 7 is a flowchart showing a step of forming the optical proximity correction model of FIG. 6;

FIGS. 8A, 8B, 8C, and 8D show steps of performing image filtering of FIG. 7;

FIG. 9 is a flowchart showing a step of optimizing the optical proximity correction model of FIG. 7;

FIG. 10 shows a step of classifying into a plurality of population groups of FIG. 9 according to an embodiment of the present inventive concept;

FIG. 11 shows an embodiment of a step of generating rank values of FIG. 9;

FIG. 12 shows an example of phase changes according to a step of determining the presence or absence of saturation of FIG. 9;

FIG. 13 shows an example of a population group for each phase adjusted according to a step of adjusting the configuration of the population group of FIG. 9;

FIG. 14 shows an example of a chromosome configuration for a stochastic genetic algorithm (SGA) according to an embodiment of the present inventive concept;

FIGS. 15A and 15B are conceptual diagrams illustrating an image alignment method; and

FIGS. 16A and 16B are conceptual diagrams illustrating a CD measurement method.

### DETAILED DESCRIPTION OF THE EMBODIMENTS

Hereinafter, embodiments of the present disclosure will be described with reference to the attached drawings. Features of the present inventive concept and methods of accomplishing the same may be understood more readily by reference to the following detailed description of embodiments of the present inventive concept and the accompanying drawings. The present inventive concept may, however, be embodied in many different forms and should not be construed as being limited to the embodiments set forth herein.

It is to be understood that the same reference numerals are assigned to the same components throughout the drawings and specification.

In this specification, the singular also includes the plural unless specifically stated otherwise in the phrase.

In addition, in describing a component of the present inventive concept, terms, such as first, second, A, B, (a), (b), can be used. These terms are only for distinguishing the components from other components, and the components should not be limited by these terms. For example, the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between the components.

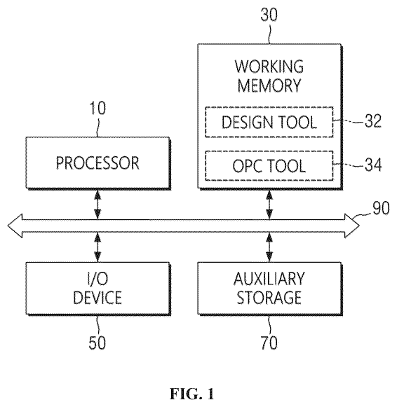

FIG. 1 is a block diagram illustrating a computing system for performing a semiconductor design according to an embodiment of the present inventive concept. Referring to FIG. 1, the computing system may include a CPU 10, a working memory 30, an input/output device 50, and an auxiliary memory device 70. The computing system of FIG. 1 may be provided as a dedicated device for the layout design of the present inventive concept, and may be equipped with various design and verification simulation programs.

The CPU 10 may execute software (e.g., an application program, an operating system, device drivers) that is to be executed on a computing system. The CPU 10 may execute an operating system (OS) loaded into the working memory 30. The CPU 10 may execute various application programs to be driven on the basis of the operating system (OS). For example, the CPU 10 may execute a layout design tool 32 and/or an OPC tool 34 loaded into the working memory 30. In addition, the computing system of the present disclosure may include processors other than the CPU 10.

The operating system (OS) and the application programs may be loaded into the working memory 30. An OS image stored in the auxiliary memory device 70 may be loaded into the working memory 30 on the basis of a booting sequence, when the computing system is booted up. The operating system (OS) may support the general input/output operations of the computing system. Application programs may be loaded into the working memory 30 for user selection or to provide basic services. The design tool 32 and/or the OPC tool 34 may be loaded into the working memory 30 from the auxiliary memory device 70.

The design tool 32 may be equipped with bias functionality that may change the shapes and locations of particular layout patterns in a manner different from those defined by the design rules. The design tool 32 may then perform a design rule check (DRR) with the modified bias data conditions. The OPC tool 34 may perform the optical proximity correction (OPC) on the layout data that is output from the design tool 32.

For example, the working memory 30 may be a volatile memory such as a dynamic random access memory (DRAM) and a static random access memory (SRAM), or may be a non-volatile memory such as a flash memory, a phase change random access memory (PRAM), a resistance random access memory, a nano floating gate memory (NFGM), a polymer random access memory (PoRAM), a magnetic random access memory (MRAM), and a ferroelectric random access memory (FRAM).

The input/output device 50 controls user input and output through the user interface devices. For example, the input/output device 50 includes a keyboard and a monitor, and the input/output device 50 may receive information input from a designer or user. The designer may receive information about semiconductor regions or data paths that might require adjusted operating characteristics, using the input/output device 50. The processing procedure, processing results, and the like of the OPC tool 34 may be displayed through the input/output device 50.

The auxiliary memory device 70 is provided as a storage medium of the computing system. The auxiliary memory device 70 may store application programs, operating system images, and various types of data. For example, the auxiliary memory device 70 may be provided as a memory card (MMC, eMMC, SD, MicroSD, etc.), a hard disk drive (HDD) or a solid state drive (SSD). For example, the auxiliary memory device 70 may include a NAND-type flash memory having a large capacity storage capacity. In addition, the auxiliary memory device 70 may include next generation non-volatile memory such as a PRAM, a MRAM, a ReRAM and a FRAM or a NOR flash memory.

A system interconnector 90 may be a system bus for providing networking inside a computing system. The CPU 10, the working memory 30, the input/output device 50, and the auxiliary memory device 70 may be electrically connected to each other through the system interconnector 90 to exchange data with each other. However, the configuration of the system interconnector 90 is not limited to the above description, and may further include arbitration means for efficient management.

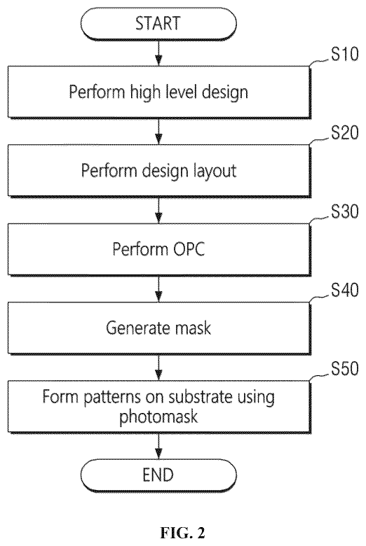

FIG. 2 is a flowchart of a method for designing and manufacturing a semiconductor device according to an embodiment of the present inventive concept. Referring to FIG. 2, in step S10, a high level design of a semiconductor integrated circuit may be performed, by using the computing system described with reference to FIG. 1. The high level design may mean describing an integrated circuit to be designed in a high level language of the computer language. For example, a high level language such as C language may be used. Circuits designed by the high level design may be more specifically represented by register transfer level (RTL) encoding or simulation. Furthermore, the code generated by register transfer level encoding may be converted into a Netlist and synthesized into the entire semiconductor device. The synthesized schematic circuit may be verified by a simulation tool, and an adjustment process may be accompanied depending on the verification results.

In step S20, a layout design for mounting the logically completed semiconductor integrated circuit on a silicon substrate may be performed. For example, the layout design may be performed with reference to a schematic circuit synthesized in a high level design or a netlist corresponding thereto. The layout design may include routing procedures which place and connect various standard cells provided in the cell library according to defined design rules.

The cell libraries for the layout design may also include information about operation, speed, power consumption, and the like of the standard cell. The cell libraries for representing a circuit of a specific gate level as a layout are defined in the most layout design tools. The layout may be a procedure for defining the shape or size of a pattern for configuring transistors and metal wirings actually formed on the silicon substrate. For example, to actually form an inverter circuit on the silicon substrate, a PMOS, a NMOS, a N-WELL, a gate electrode, and layout patterns such as metal wirings placed on them may be appropriately disposed. To this end, an appropriate inverter among the inverters already defined in the cell library may be first searched and selected.

In addition, routing may be performed on the selected and placed standard cells. For example, routing with upper level wirings may be performed on the selected and placed standard cells. The standard cells may be connected to each other to be suitable for the design through the routing procedures. Most of the series of processes may be performed automatically or manually by the layout design tool. Additionally, the placement and routing of the standard cells may be performed automatically using a separate Place & Routing tool.

After the routing, the layout may be verified whether there is a portion that violates the design rule. The items to be verified may include a DRC (Design Rule Check), which verifies whether the layout is correctly set to be suitable for the design rules, an ERC (Electrical Rule Check), which verifies whether the layout is correctly set without any internal electrical interruptions, an LVS (Layout vs Schematic), which checks whether the layout matches the gate level netlist.

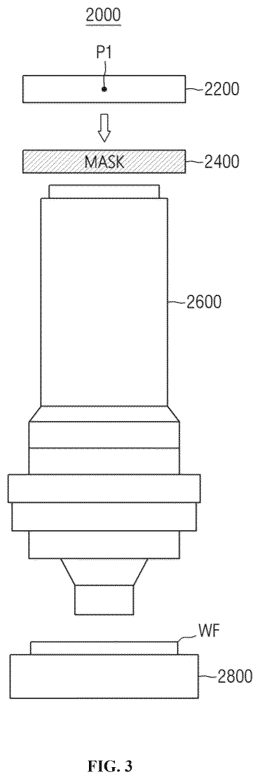

In step S30, an optical proximity correction (OPC) procedure may be performed. Layout patterns obtained through the layout design may be implemented on the silicon substrate, using a photolithography process. The optical proximity correction may be a technique for correcting distortion phenomena that may occur in the photolithography process. For example, distortion phenomena such as refraction and process effects, which may be caused by light characteristics at the time of exposure using a laid-out pattern, may be corrected by the optical proximity correction. The shapes and locations of the patterns within the designed layout may be changed (biased), while performing the optical proximity correction. A more specific description of the optical proximity correction will be given later with reference to FIGS. 3 to 5.

In step S40, a photomask may be manufactured on the basis of the layout changed by the optical proximity correction. For example, the photomask may be manufactured in a manner of drawing a layout pattern, using a chromium film coated on a glass substrate.

In step S50, a semiconductor device may be manufactured, using the generated photomask. In the manufacturing process of the semiconductor device using the photomask, various types of exposure and etching processes may be repeated. The forms of the patterns configured at the time of layout design may be sequentially formed on the silicon substrate, through such processes.

FIG. 3 is a conceptual diagram illustrating a photolithography system using a photomask manufactured according to an embodiment of the present inventive concept. Referring to FIG. 3, a photolithography system 2000 may include a light source 2200, a photomask 2400, a reduction projection device 2600, and a substrate stage 2800. However, the photolithography system 2000 may further include components that are not shown in FIG. 3. For example, the photolithography system 2000 may further include sensors used to measure the height and tilt of a surface of a substrate WF.

The light source 2200 may emit light. The light emitted from the light source 2200 may be emitted to the photomask 2400. For example, a lens may be provided between the light source 2200 and the photomask 2400 to adjust the optical focus. The light source 2200 may include an ultraviolet light source (e.g., a KrF light source with a wavelength of about 234 nm, an ArF light source with a wavelength of about 193 nm, or the like). Although the light source 2200 may include one point light source P1, the present inventive concept is not limited thereto. In embodiments of the present inventive concept, light source 2200 may include a plurality of point light sources.

In order to print (mount) the designed layout on the substrate WF, the photomask 2400 may include image patterns. The image patterns may be formed of a transparent region and an opaque region. The transparent region may be formed by etching a metal layer (e.g., a chrome film) on the photomask 2400. The transparent region allows light emitted from the light source 2200 to pass through. The opaque region, on the other hand, may block light without allowing it to pass through.

The reduction projection device 2600 may be provided with light that passes through the transparent region of the photomask 2400. The reduction projection device 2600 may match the layout patterns printed on the substrate WF with the image patterns of the photomask 2400. The substrate stage 2800 may support the substrate WF. For example, the substrate WF may include a silicon wafer.

The reduction projection device 2600 may include an aperture. The aperture may be used to increase the depth of focus of the light emitted from the light source 2200. For example, the aperture may include a dipole aperture or a quadrupole aperture. The reduction projection device 2600 may further include a lens to adjust the optical focus.

The transparent region included in the image patterns of the photomask 2400 may allow light emitted from the light source 2200 to pass through. The light that has passed through the photomask 2400 may be emitted onto the substrate WF through the reduction projection device 2600. Therefore, patterns corresponding to the image patterns of the photomask 2400 may be printed on the substrate WF.

In addition, as the degree of integration of semiconductor devices increases, a distance between the image patterns of the photomask 2400 becomes very short, and a width of the transparent region becomes very narrow. Due to such “proximity”, light interference and diffraction may occur, and a distorted layout that is different from the desired layout may be printed on the substrate WF. If a distorted layout is printed on the substrate WF, the designed circuit may operate abnormally.

Resolution enhancement techniques may be used to prevent the layout distortion. The optical proximity correction is an example of a resolution enhancement technique. According to the optical proximity correction, the degree of distortion such as optical interference and diffraction may be predicted in advance. Furthermore, the image patterns to be formed on the photomask 2400 may be biased in advance on the basis of the predicted results. Accordingly, a desired layout may be printed on the substrate WF.

The optical proximity correction may be performed to adjust the layout of a single layer. In addition, in the semiconductor processing, the semiconductor device may be implemented to include a plurality of layers. For example, the semiconductor device may include the plurality of metal layers stacked together to implement a particular circuit. Therefore, the optical proximity correction may be performed independently for each of the plurality of layers.

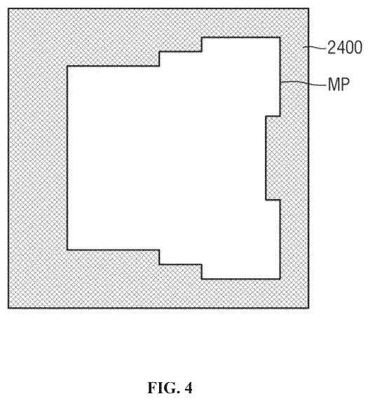

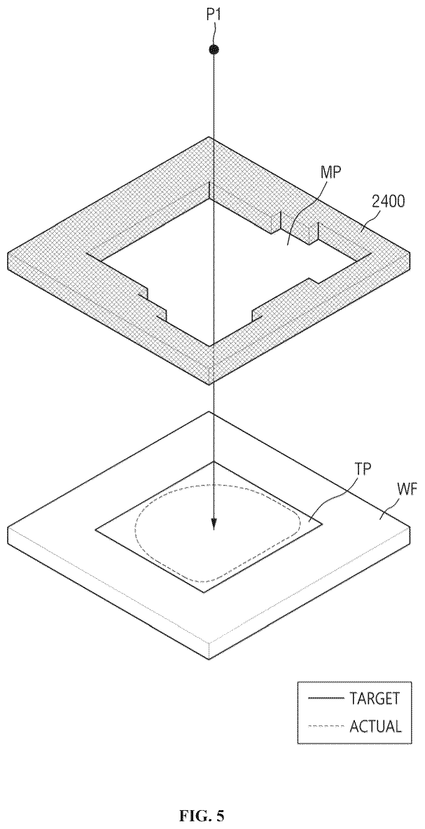

FIG. 4 shows an example of a photomask included in the photolithography system of FIG. 3. FIG. 5 shows an example in which a circuit pattern is printed on the substrate, by the use of the photomask of FIG. 4.

Referring to FIG. 4, a photomask 2400 may include a mask pattern MP. The photomask 2400 may include a transparent region and an opaque region. The opaque region may block light without allowing it to pass through. In addition, the transparent region may allow light emitted from the light source 2200 of FIG. 3 to pass through. The light that has passed through the photomask 2400 may be emitted onto the substrate WF of FIG. 5. The mask pattern MP may form a transparent region. For example, the shape of the transparent region may be formed on the substrate WF.

Referring to FIG. 5, the point light source P1 of the light source 2200 of FIG. 3 may emit light to the photomask 2400. The emitted light passes through the transparent region of the mask pattern MP, and may be emitted onto the substrate WF. Accordingly, a target pattern TP corresponding to the mask pattern MP may be printed on the substrate WF. When the photomask 2400 includes the mask pattern MP, an actual layout of dotted lines that is substantially identical to the target layout of solid lines (that is, with less error) may be printed on the substrate WF.

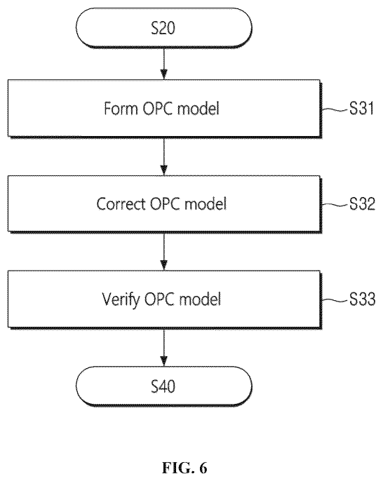

Hereinafter, specific procedures for the optical proximity correction according to the embodiment of the present inventive concept will be described with reference to FIGS. 6 to 9. For reference, FIGS. 6 to 9 show steps/operations of the optical proximity correction method performed on the computing system of FIG. 1. Accordingly, in the following descriptions, if the subject matters of particular steps/operations are omitted, it will be understood that they are performed on the computing system of FIG. 1.

FIG. 6 is a flowchart specifically showing a step (S30) for executing the optical proximity correction procedure of FIG. 2. Referring to FIG. 6, the optical proximity correction (S30) procedure according to the embodiment of the present inventive concept includes a step (S31) of forming an optical proximity correction model, a step (S32) of correcting the optical proximity correction model according to a simulation result on the optical proximity correction model, and a step (S33) of verifying the optical proximity correction model.

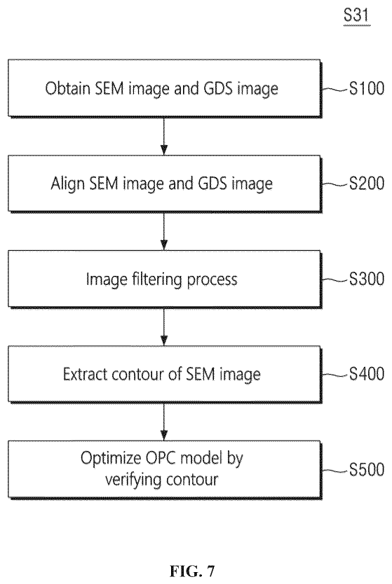

FIG. 7 is a flowchart specifically showing the step (S31) of forming the optical proximity correction model of FIG. 6. Referring to FIG. 7, more specifically, the step (S31) of forming the optical proximity correction model may include a step (S100) of obtaining a scanning electron microscope (SEM) image and a graphic data system (GDS) image, a step (S200) of aligning the SEM image and the GDS images, a step (S300) of performing image filtering, a step (S400) of extracting the contours of the SEM images, and a step (S500) of verifying the contours to optimize the optical proximity correction model.

The SEM image is an average image of the plurality of images that are the result of taking images of any one pattern with a scanning electron microscope a plurality of times. The GDS image is obtained by converting a pre-designed layout into an image, and is an image that has undergone a clipping process. The GDS image may be a CAD (computer-aided design) image.

The step (S200) of aligning the SEM and GDS images may be performed manually or on a machine learning basis.

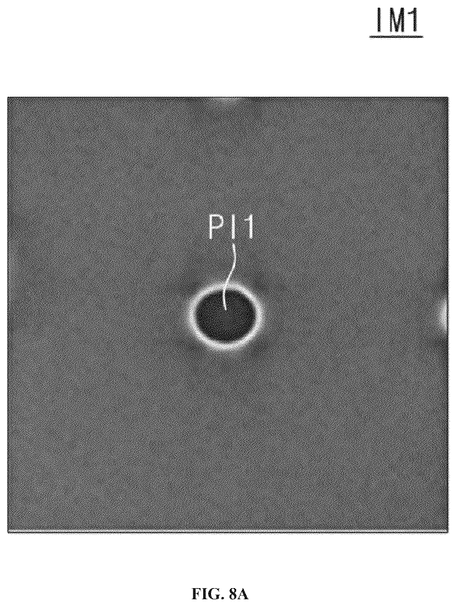

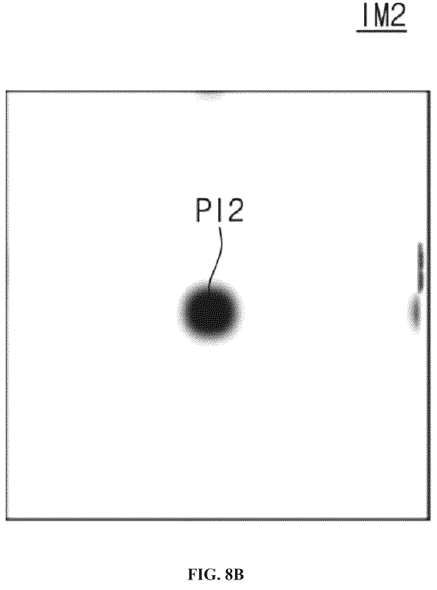

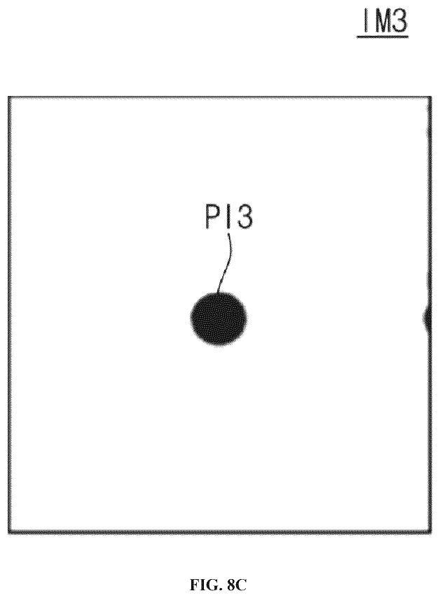

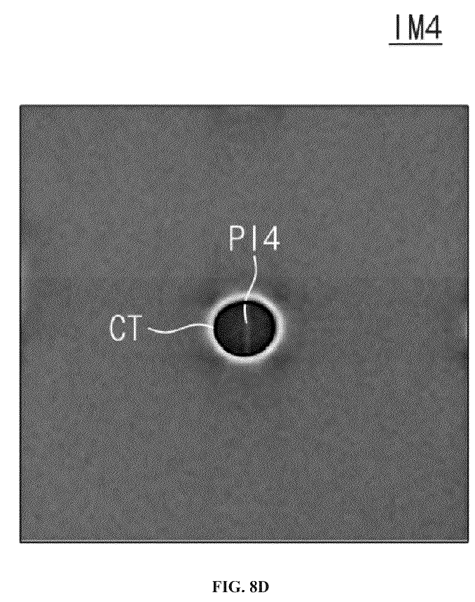

FIGS. 8A to 8D illustrate a step (S300) of performing image filtering of FIG. 7. Referring to FIGS. 8A to 8D, the step (S300) of performing the image filtering may include a step of forming a background image, and a step of extracting a result image on the basis of the SEM image and the background image.

A first image IM1 of FIG. 8A may be called a SEM image, and the first image IM1 includes a first pattern image PI1. The first pattern image PI1 may include, for example, a black circle, and a white band surrounding the black circle. The black circle may correspond to an upper face of the pattern, and the white band may correspond to a sloped side wall of the pattern.

A second image IM2 of FIG. 8B may be called a background image, and the second image IM2 includes a second pattern image PI2. The second image IM2 may be a binary image similar to the first image IM1. The second pattern image PI2 may have a blurred outline.

A third image IM3 of FIG. 8C may be called a result image, and the third image IM3 includes a third pattern image PI3. The third image IM3 may be formed by processing the first image IM1 and the second image IM2, using techniques such as blending and smoothing. The third pattern image PI3 may have a clear outline. The contour of the SEM image may be extracted from the third pattern image PI3.

A fourth image IM4 of FIG. 8D is a representation of the first image IM1 and the contour CT together. The fourth image IM4 includes a fourth pattern image PI4 and a contour CT, and the fourth pattern image PI4 is the same as the first pattern image PI1. The contour CT may surround the fourth pattern image PI4.

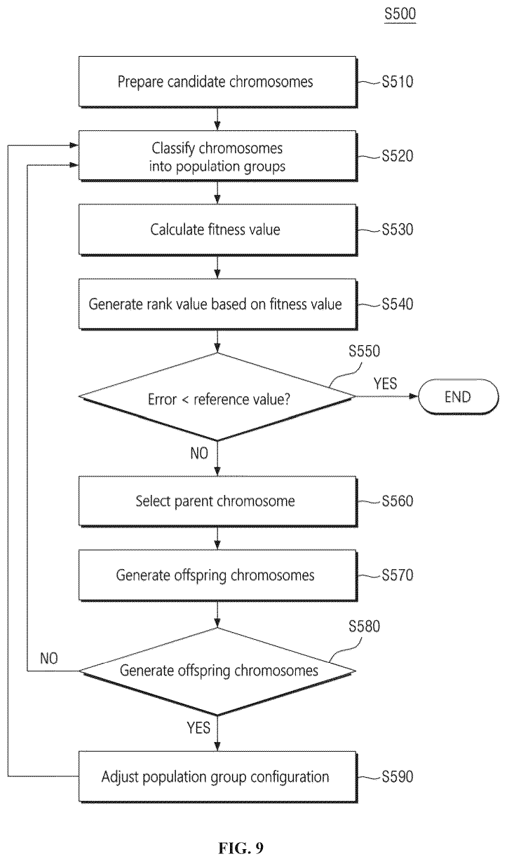

FIG. 9 is a flowchart showing a step (S500) of optimizing the optical proximity correction model of FIG. 7. Optimization of the optical proximity correction model according to embodiments of the present inventive concept may be performed through a genetic algorithm. The genetic algorithm is a computational algorithm that performs global optimization by imitating the evolutionary process of a nature world. The genetic algorithms may increase the probability that solutions with high fitness are selected, and may prevent the selected solutions from falling into a local optimum. For example, the genetic algorithm according to embodiments of the present inventive concept is a stochastic genetic algorithm (STG), which is a genetic algorithm based on a probability distribution (e.g., a Gaussian distribution or a Poisson distribution).

Referring to FIG. 9, the step (S500) of optimizing the optical proximity correction model may include a step (S510) of preparing candidate chromosomes, a step (S520) of classifying into population groups, a step (S530) of calculating a fitness value of the candidate chromosomes, a step (S540) of generating a rank value on the basis of the fitness ranking, a step (S550) of determining whether the algorithm ends, a step (S560) of selecting a parent chromosome when the algorithm does not end, a step (S570) of generating offspring chromosomes, a step (S580) of determining whether the fitness change is saturated, and a step (S590) of adjusting the configuration of the population group when it is saturated, and after that, steps S520 to S590 may be repeated until termination conditions are satisfied (e.g., the fitness value reaches the standard value). For example, the generated offspring chromosomes may be classified into the plurality of groups again.

At this time, the chromosomes may represent the solutions to the problem to be solved, and genes included in each chromosome may represent the variables of the problem to be solved. For example, the variables of problem may represent nonlinear parameters of the optical proximity correction model. For example, the parameters of the optical proximity correction model may be first parameters related to image alignment, second parameters related to image filtering, and/or third parameters related to CD (critical dimension) measurement. The first parameters may include, for example, x-direction displacements and y-direction displacements of the SEM images in the image alignment process. The second parameters may be parameters related to the processing technique in the image filtering process. The second parameters may include, for example, at least one of a mixing rate, a contrast intensity, and/or a threshold value. The third parameters may include, for example, the location and number of pixels selected when calculating the CD average.

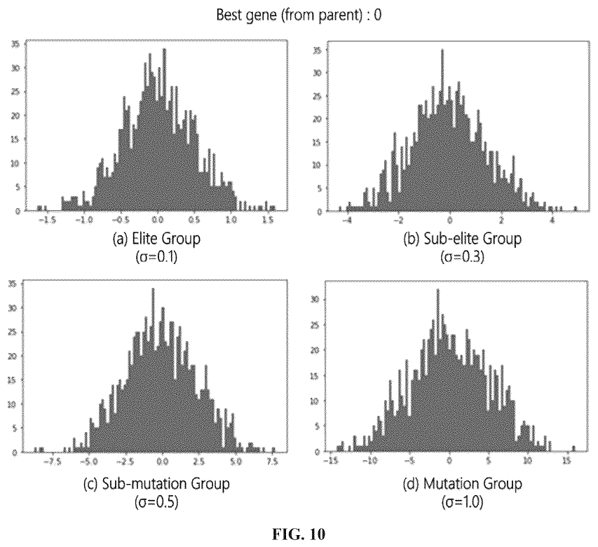

In step S510, candidate chromosomes may be randomly generated. For example, in step S510, candidate solutions represented by chromosomes may be prepared. Thereafter, in step S520, the generated chromosomes may be classified into the plurality of population groups. According to embodiments of the present inventive concept, chromosomes of one generation (i.e., population of one generation) may be classified into the plurality of population groups, each of which follows a Gaussian distribution. At this time, the ratio of each population group occupied in one generation and the sigma value of the Gaussian distribution may be set to be different, and in each population group, a range in which the genes of the offspring chromosomes are determined on the basis of the genes of the parent chromosome may be different from each other. The step (S520) will be described in further detail with reference to FIG. 10.

FIG. 10 shows the step (S520) of classifying into the plurality of population groups of FIG. 9 according to an embodiment of the present inventive concept. Referring to FIG. 10, it is shown that the population within one generation is classified into four population groups of an elite, a sub-elite, a sub-mutation, and a mutation. In a subsequent step (S570), each population may generate offspring chromosomes in accordance with a Gaussian distribution. For example, a range (or a search range) in which genes are inherited from parent chromosomes to offspring chromosomes may change in accordance with the Gaussian sigma value (0.1, 0.3, 0.5, 1.0) of each population group.

For example, referring to FIG. 10, assuming that zero is the most common gene, probability at which genes in the range of −1 to 1 are inherited increases in the case of the elite group which is the first group, probability at which genes in the range of −2 to 1 are inherited increases in the case of the sub-elite group which is the second group, probability at which genes in the range of −5 to 5 are inherited increases in the case of the sub-mutant group which is the third group, and probability at which genes in the range of −10 to 10 are inherited increases in the case of the mutation group which is the fourth group. For example, the smaller the Gaussian sigma value is, the narrower the search range becomes, and there is a high probability that the genes of the next generation offspring chromosomes (that is, the parameters of the optical proximity model) are inherited around the best gene of the parent generation. Since the best gene is highly related to the optimal solution, there may be a high probability that the parameters of the optical proximity model increases converge to the optimal solution.

For example, the SGA according to the embodiment of the present inventive concept may configure the next generation according to Gaussian mutation, and may adjust the genetic range only by the Gaussian sigma value. In this way, by dividing the chromosomes of one generation into various population groups and inheriting them according to different Gaussian distributions, it is possible to prevent convergence to a local optimum. In addition, the number of population groups and the Gaussian sigma value of each group shown in FIG. 10 are examples, and the present inventive concept is not limited thereto. For example, as the number of population groups increases, diversity of the optimal solution may be guaranteed. Further, according to steps S580 and S590, which will be described later, the configuration ratio of the population group may be changed flexibly in consideration of whether the change in fitness is saturated.

Returning again to FIG. 9, in step S530, fitness values may be calculated for each chromosome. In the case of an embodiment of the present inventive concept, the problem sought to be solved is to find contours that have lower error values than a reference value (i.e., accuracy and reliability are increased). For example, the error value at this time may indicate a CD error value or an EP (edge placement) error value. For example, the fitness value according to embodiments of the present inventive concept may be a CD error value or an EP error value. For example, such error values may be expressed as a root mean square (RMS) error value.

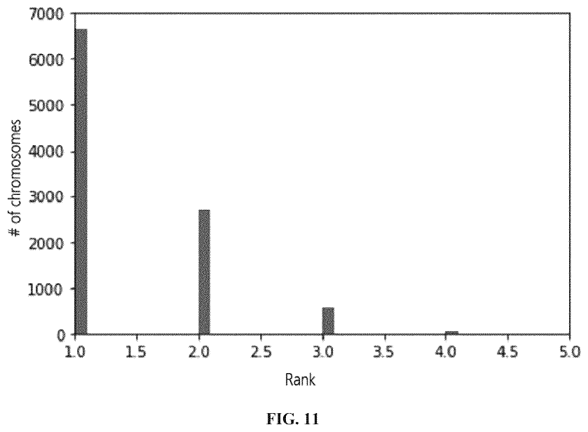

In step S540, rank values of the chromosomes may be generated on the basis of the calculated fitness value. For this purpose, the calculated fitness values may be arranged in high order and divided into the plurality of phases depending on the fitness values. Rank values corresponding to each phase may then be generated. For example, the rank values according to embodiments of the present inventive concept may be generated such that the fitness values follow a Poisson distribution for the rank values. The step S540 will be described in more detail with reference to FIG. 11.

FIG. 11 shows an embodiment of step (S540) of generating the rank values of FIG. 9. Referring to FIG. 11, the fitness values follow a Poisson distribution for the rank values. According to the Poisson distribution, the smaller the rank value is (in other words, as the rank is close to 1), the more chromosomes with higher fitness values are distributed. For example, the smaller the rank value is, the higher the probability that chromosome with a high fitness value will be selected. In a subsequent step S560, a parent chromosome may be selected among the chromosomes that follow the Poisson distribution in this way. In addition, the present inventive concept is not limited thereto, and the fitness value may follow any other probability distribution in which the smaller the rank value is, the higher the fitness value may be.

Returning to FIG. 9 again, in step S550, the highest fitness value and a predetermined reference value may be compared to determine whether the algorithm ends. If the highest fitness value is lower than a predetermined reference value (YES), the algorithm may end, and if the fitness value is greater than or equal to the reference value (NO), the algorithm may continue. In addition, the algorithm may end even when a predetermined number of repetitions has elapsed. When the algorithm ends, the optimal solution of the optical proximity correction model may be extracted. For example, a contour having a CD error value or an EP error value lower than the reference value may be output.

If the algorithm does not end in step S550, the parent chromosome may be selected in step S560. As explained using FIG. 11, the parent chromosome may be selected among the chromosomes which follows the Poisson distribution. Therefore, genes of chromosomes with high fitness have the highest probability of being inherited to the next generation. However, since genes of chromosomes with rank values of 2 and 3 may also be inherited to the next generation, diversity of optimal solutions may be ensured.

In step S570, offspring chromosomes may be generated from the selected parent chromosomes. According to an embodiment of the present inventive concept, offspring chromosomes may be generated on the basis of a Gaussian distribution according to the population classified in step S520. For example, when the gene of the parent chromosome is defined as Geneₚₐᵣₑₙₜ, a gene Gene_{offspring} possessed by the offspring chromosome may be generated according to Formula 1 below.

Gene_{offspring}=range/2*N(0,σ)+Geneₚₐᵣₜₑₙₜ [Formula 1]

Here, Range corresponds to the search range for each population group described with reference to FIG. 10, and a σ value corresponds to the Gaussian sigma value of each population group. That is, the genes possessed by the offspring chromosomes may be generated within the range of Gaussian distribution N (0, 6) on the basis of the genes of the parent chromosome. By generating the offspring chromosomes on the basis of different Gaussian distributions instead of performing crossover calculations on the parent chromosomes, a variety of genes around the best gene may be generated with each generation, and since the best gene is highly related to the optimal solution, the convergence to the final optimal solution may finally increase.

In step S580, it may be determined whether the change in fitness is saturated. In the SGA according to the embodiment of the present inventive concept, the ratio of chromosomes having good genes will increase with each generation, and the ratio of chromosomes having good genes being selected as parent chromosomes will increase. Accordingly, the ratio of population groups that have a narrow search range around the parent chromosome may be adjusted to increases relatively, depending on whether the fitness changes are saturated. In this specification, a set of generations with different population group configurations is represented by one phase.

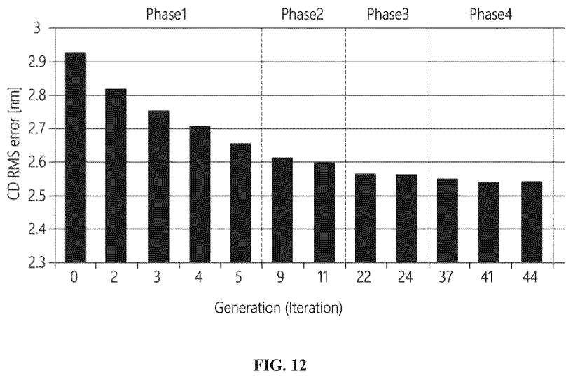

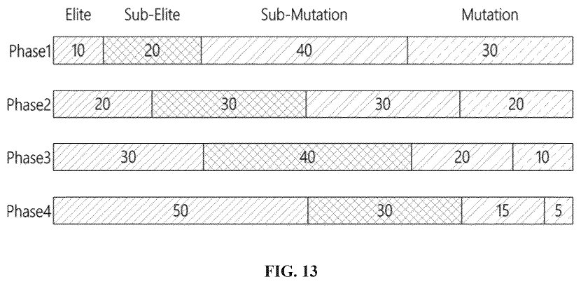

Therefore, in step S580, to determine whether saturation is present, a rate of change between the maximum fitness value among the fitness values calculated in step S530 and the maximum fitness value among the previously calculated fitness values may be compared with a predetermined reference value. If the rate of change is greater than or equal to the reference value, the configuration of the population groups may be remained in the same manner. The step S520 may then be performed on the generated offspring chromosomes. However, if the rate of change is smaller than the reference value, the configuration of the population group may be adjusted in step S590, and the step S520 may be performed according to the configuration of the population group changed for the generated offspring chromosomes. The steps S580 to S590 will be described in further detail with reference to FIGS. 12 and 13.

FIG. 12 shows an example of phase changes in step S580 of FIG. 9, which determines whether saturation is present. Referring to FIG. 12, the change in each phase varies depending on the rate of change of the highest fitness value (in this case, the rate of change of the highest CD error value) among the fitness values calculated for the chromosomes. As described above, when the saturation condition that divides each phase is reached, the configuration of the population groups may be changed according to the step S590.

FIG. 13 shows an example of the population group for each phase adjusted according to step (S590) of adjusting the configuration of the population group of FIG. 9. For example, each phase of FIG. 13 may correspond to each phase of FIG. 12. Referring to FIG. 13, the first phase is configured such that the elite, sub-elite, sub-mutant, and mutant group occupy 10%, 20%, 40%, and 30% of the total population, respectively. Then, as the phase progresses, the ratio of the elite group becomes relatively high, and the ratio of the mutant group becomes relatively low. For example, as described above, according to the embodiment of the present inventive concept, the optimization phase may be divided into a plurality of phases, and the phases are divided with each generation, and the ratio of narrow search range (i.e., the elite group) may be configured to increase.

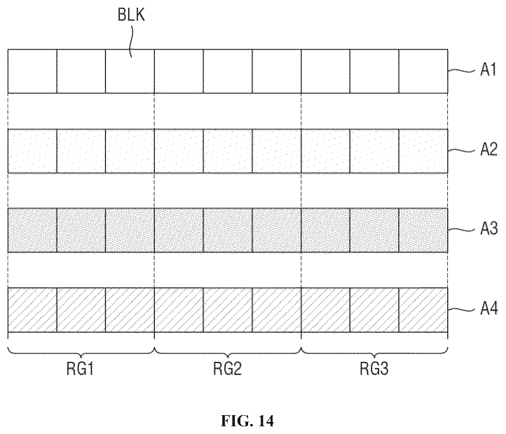

FIG. 14 shows an example of a chromosome configuration for a stochastic genetic algorithm (SGA) according to an embodiment of the present inventive concept. Referring to FIG. 14, the first to fourth chromosomes A1, A2, A3, and A4 may be selected by the parent chromosome selection (S560) of FIG. 9. As described with reference to FIG. 9, the first to fourth chromosomes A1, A2, A3, and A4 may be parent chromosomes selected from chromosomes whose fitness values have a Poisson distribution according to the rank values. Each of the first to fourth chromosomes A1, A2, A3, and A4 may include the plurality of gene blocks BLK. Each gene block BLK may include different variables from each other.

Each of the first to fourth chromosomes A1, A2, A3, and A4 may include at least two or more regions. For example, the first to fourth chromosomes A1, A2, A3, and A4 may include a first region RG1, a second region RG2, and a third region RG3. The gene blocks BLK located within the first region RG1 may include first variables. The gene blocks BLK located within the second region RG2 may include second variables, and the gene blocks BLK located within the third region RG3 may include third variables. For example, the first variables may be first parameters related to image alignment. The second variables may be second parameters related to image filtering, and the third variables may be third parameters related to CD measurement.

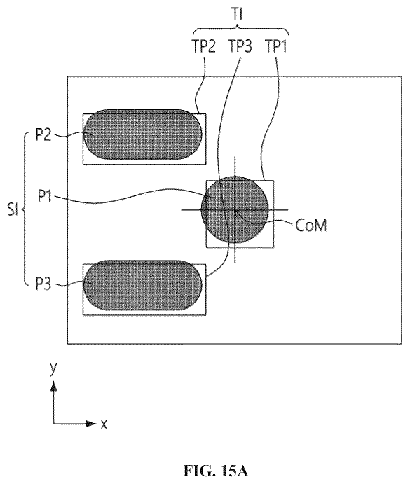

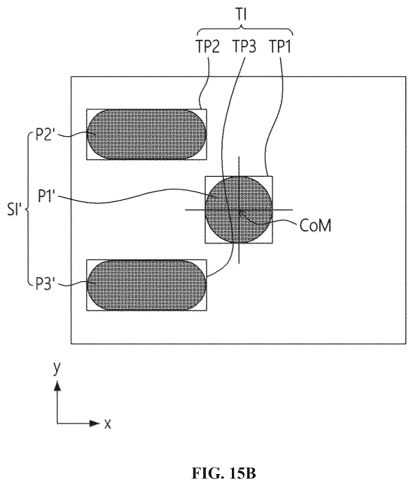

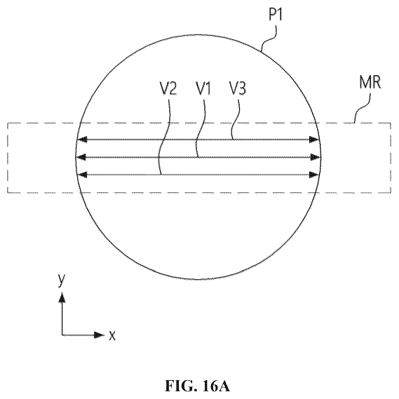

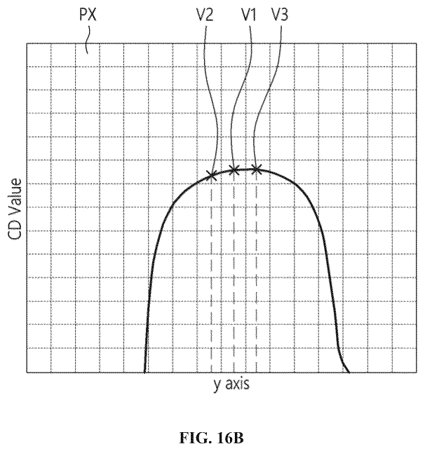

FIGS. 15A, 15B, 16A and 16B are conceptual diagrams for explaining specific processes of a method for forming an optical proximity correction model according to an embodiment of the present inventive concept. More specifically, FIGS. 15A and 15B are conceptual diagrams illustrating an image alignment method, and FIGS. 16A and 16B are conceptual diagrams illustrating a CD measurement method.

Referring to FIGS. 15A and 15B, the image alignment may be alignment of the SEM image SI and the GDS image TI. The SEM image SI may include, for example, first to third patterns P1, P2, and P3. The first pattern P1 may be located at the center of the SEM image SI. The first to third patterns P1, P2, and P3 may be spaced apart from each other.

The GDS image TI may include, for example, first to third target patterns TP1, TP2, and TP3. Each of the first to third target patterns TP1, TP2, and TP3 may be adjacent to each of the first to third patterns P1, P2, and P3, respectively. Each of the first to third target patterns TP1, TP2, and TP3 may have a polygonal shape with vertices. At least a part of each of the first to third patterns P1, P2, and P3 may be located outside their respective target pattern of the first to third target patterns TP1, TP2, and TP3. For example, the first to third patterns P1, P2, and P3 may be offset from their respective target pattern of the first to third target patterns TP1, TP2, and TP3.

By moving the SEM image SI in the x-direction and/or the y-direction on the basis of a center of mass COM of the first pattern P1, the SEM image SI′ and the GDS image TI may be aligned. Accordingly, the first to third patterns P1′, P2′, and P3′ may be included in the first to third target patterns TP1, TP2, and TP3.

Referring to FIGS. 16A and 16B, the CD of the first pattern P1 shown in FIGS. 15A and 15B may be measured. The CD measurement may be performed in a multi-point manner. More specifically, the CD measurements may be performed at a plurality of locations within the measurement range MR. The first to third CD values V1, V2, and V3 may be CD values in the x-direction of the first pattern P1 measured at different locations from each other. For example, the first to third CD values V1, V2, and V3 may be measured in units of pixels Px having uniform phases in the y-direction. The first CD value V1 may be measured at a pixel Px that includes the center of mass of the first pattern P1 (see COM of FIGS. 15A and 15B), and the first CD value V1 may be greater than the second CD value V2 and the third CD value V3.

For example, the CD of the first pattern P1 may be determined as the first CD value V1. In addition, the CD of the first pattern P1 may be determined as the average of the first to third CD values V1, V2, and V3. In addition, the CD of the first pattern P1 may be determined as the average of four or more CD values including the first CD value V1.

The first parameters related to the image alignment described with reference to FIGS. 15A and 15B, and the third parameters related to the CD measurement described with reference to FIGS. 16A and 16B may be variables of the genetic algorithms that find a contour having an error value lower than the reference value (that is, accuracy and reliability may be increased).

According to embodiments of the present inventive concept, in the process of optimizing the optical proximity correction model, unlike existing genetic algorithms, the parent chromosomes are selected according to the Poisson distribution, and the offspring chromosomes are generated according to Gaussian distribution. In addition, by changing the configuration of the population group that follows the Gaussian distribution depending on the rate of change in the fitness value, the diversity of optimal solutions of the non-linear parameters may be guaranteed. Furthermore, the calculated solutions may be prevented from converging to a local optimum value. Although the embodiments described above are described as a method for optimizing an optical proximity correction model, a stochastic genetic algorithm (SGA) according to embodiments of the present inventive concept may also be applied to other types of nonlinear parameter optimization, in addition to optimization of the optical proximity correction model.

In addition, the method for optimizing the optical proximity correction model according to embodiments of the present inventive concept may be executed on the computing system of FIG. 1. For example, the OPC tool 34 of FIG. 1 may non-transitorily store one or more computer programs, and the computer program may include one or more instructions that cause the CPU 10 to perform operations/methods according to various embodiments of the present inventive concept when loaded into the working memory 30. For example, the CPU 10 may perform the operations/methods according to various embodiments of the present inventive concept by executing one or more loaded instructions.

For example, the computer program non-temporarily stored in the OPC tool 34 may perform the following: an operation of preparing candidate chromosomes representing candidate solutions, and each of the candidate chromosomes including a plurality of genes; an operation of classifying the candidate chromosomes into a plurality of population groups each of which follows a Gaussian distribution; an operation of calculating a fitness value for each of the candidate chromosomes; an operation of generating a rank value on the basis of the calculated fitness value; an operation of determining whether the genetic algorithm ends on the calculated fitness value; an operation of selecting a parent chromosome among the candidate chromosomes when the genetic algorithm does not end; an operation of generating offspring chromosomes from the parent chromosome in which the genes of the offspring chromosomes follow a Gaussian distribution of a population group to which the parent chromosome belongs; an operation of determining whether the fitness value change is saturated; an operation of adjusting the configuration of the plurality of population groups when the fitness value change is saturated; and an operation of classifying the generated offspring chromosomes into the plurality of population groups.

Until now, various embodiments of the present inventive concept and effects according to embodiments of the present inventive concept have been mentioned with reference to FIGS. 1 to 16B. The effects of the technical idea of the present inventive concept are not restricted to those set forth herein, and other unmentioned technical effects will be clearly understood by one of ordinary skill in the art to which the present inventive concept pertains by referencing the detailed description of the present inventive concept given below.

Although operations are shown in a specific order in the drawings, it should be understood that desired results may be obtained when the operations are performed in the specific order, a sequential order, or a different order. In certain situations, multitasking and parallel processing may be useful. According to the above-described embodiments, it should not be understood that the separation of various configurations is necessarily required, and it should be understood that the described program components and systems may generally be integrated together into a single software product or be packaged into multiple software products.

While the present inventive concept has been described with reference to embodiments thereof, it will be understood by those of ordinary skill in the art that various changes in form and details may be made thereto without departing from the spirit and scope of the present inventive concept.

What is claimed is:

1. A method for optimizing an optical proximity correction model, the method comprising:
acquiring a SEM image, which is an average image of a plurality of images, and a GDS image, which is an image of a designed layout;
aligning the SEM image and the GDS image with each other;
performing image filtering on the SEM image;
extracting a contour from the SEM image; and
optimizing the optical proximity correction model by verifying the contour, wherein the optimization of the optical proximity correction model is performed by a genetic algorithm;
preparing candidate chromosomes representing candidate solutions, wherein each of the candidate chromosomes includes a plurality of genes;
classifying the candidate chromosomes into a plurality of population groups, each of which follows a Gaussian distribution;
calculating a fitness value for each of the candidate chromosomes;
determining whether the genetic algorithm ends on the basis of the calculated fitness value;
selecting a parent chromosome among the candidate chromosomes, when the genetic algorithm does not end;
generating offspring chromosomes from the parent chromosome, wherein genes of the offspring chromosomes follow the Gaussian distribution of the population group to which the parent chromosome belongs; and
classifying the generated offspring chromosomes into the plurality of population groups.

2. The method for optimizing the optical proximity correction model of claim 1,
wherein the plurality of genes correspond to variables of the genetic algorithm, and
the variables of the genetic algorithm include first parameters related to an image alignment, second parameters related to image filtering, and third parameters related to CD (critical dimension) measurement.

3. The method for optimizing the optical proximity correction model of claim 1,
wherein the fitness value is either a CD (critical dimension) error value or an EP (edge placement) error value.

4. The method for optimizing the optical proximity correction model of claim 1,
wherein optimizing the optical proximity correction model further includes generating a rank value on the basis of the calculated fitness value, before determining whether the genetic algorithm ends,
wherein generating the rank value includes generating the rank value such that the fitness value follows a Poisson distribution for the rank value, and
wherein selecting the parent chromosome includes selecting the parent chromosome among chromosomes that follow the Poisson distribution.

5. The method for optimizing the optical proximity correction model of claim 1,
wherein each of the plurality of population groups follows a Gaussian distribution in which a value corresponding to best gene among the plurality of genes is an average and a Gaussian sigma value is a standard deviation, and
the value corresponding to the best gene is 0.

6. The method for optimizing the optical proximity correction model of claim 1,
wherein determining whether the genetic algorithm ends includes determining that the genetic algorithm ends, when the calculated fitness value is less than a predetermined reference value or the number of repetitions of a predetermined genetic algorithm elapses.

7. The method for optimizing the optical proximity correction model of claim 1,
wherein optimizing the optical proximity correction model further includes determining whether a change in fitness value is saturated; and
adjusting a configuration of the plurality of population groups, when the change in fitness values is saturated.

8. The method for optimizing the optical proximity correction model of claim 7,
wherein determining whether the change in the fitness value is saturated determines that the change in the fitness value is saturated, when a rate of change between a maximum value among the calculated fitness values and a maximum value among fitness values calculated in a previous generation is less than a predetermined reference value.

9. The method for optimizing the optical proximity correction model of claim 7,
wherein adjusting the configuration of the plurality of population groups includes increasing a ratio of a first population group having a smallest first Gaussian sigma value among Gaussian sigma values of the plurality of population groups, and reducing a ratio of a second population group having a largest second Gaussian sigma value.

10. A method for manufacturing a semiconductor device, the method comprising:
designing a layout;
performing an optical proximity correction on the designed layout; and
forming photoresist patterns on a substrate, by using a photolithography process that uses a photomask that is manufactured with a corrected layout generated from the optical proximity correction,
wherein performing the optical proximity correction includes:
forming an optical proximity correction model;
correcting the optical proximity correction model depending on simulation results on the optical proximity correction model; and
verifying the corrected optical proximity correction model,
wherein forming the optical proximity correction model includes optimizing the optical proximity correction model by using a genetic algorithm, and
wherein optimizing the optical proximity correction model includes:
preparing candidate chromosomes representing candidate solutions, wherein each of the candidate chromosomes includes a plurality of genes;
classifying the candidate chromosomes into a plurality of population groups, each of which follows a Gaussian distribution;
calculating a fitness value for each of the candidate chromosomes;
determining whether the genetic algorithm ends on the basis of the calculated fitness value;
selecting a parent chromosome among the candidate chromosomes, when the genetic algorithm does not end;
generating offspring chromosomes from the parent chromosome, wherein genes of the offspring chromosomes follow the Gaussian distribution of a population group to which the parent chromosome belongs; and
classifying the generated offspring chromosomes into the plurality of population groups.

11. The method for manufacturing the semiconductor device of claim 10,
wherein the plurality of genes correspond to variables of the genetic algorithm, and
the variables of the genetic algorithm include first parameters related to an image alignment, second parameters related to image filtering, and third parameters related to a CD (critical dimension) measurement.

12. The method for manufacturing the semiconductor device of claim 10,
wherein the fitness value is either a CD (critical dimension) error value or an EP (edge placement) error value.

13. The method for manufacturing the semiconductor device of claim 10,
wherein optimizing the optical proximity correction model further includes generating a rank value on the basis of the calculated fitness value, before determining whether the genetic algorithm ends,
wherein generating of the rank value includes generating the rank value such that the fitness value follows a Poisson distribution for the rank value, and
wherein selecting of the parent chromosome includes selecting the parent chromosome among chromosomes that follow the Poisson distribution.

14. The method for manufacturing the semiconductor device of claim 10,
wherein each of the plurality of population groups follows a Gaussian distribution in which a value corresponding to best gene among the plurality of genes is an average and a Gaussian sigma value is a standard deviation, and
the value corresponding to the best gene is 0.

15. The method for manufacturing the semiconductor device of claim 10,
wherein determining whether the genetic algorithm ends includes determining that the genetic algorithm ends, when the calculated fitness value is less than a predetermined reference value or the number of repetitions of the predetermined genetic algorithm elapses.

16. The method for manufacturing the semiconductor device of claim 10,
wherein optimizing the optical proximity correction model further includes:
determining whether a change in fitness value is saturated; and
adjusting a configuration of the plurality of population groups, when the change in fitness values is saturated.

17. The method for manufacturing the semiconductor device of claim 16,
wherein determining whether the change in the fitness value is saturated determines that the change in the fitness value is saturated, when a rate of change between a maximum value among the calculated fitness values and a maximum value among fitness values calculated in a previous generation is less than a predetermined reference value.

18. The method for manufacturing the semiconductor device of claim 16,
wherein adjusting the configuration of the plurality of population groups includes:
increasing a ratio of a first population group having smallest first Gaussian sigma value among Gaussian sigma values of the plurality of population groups; and
reducing a ratio of a second population group having largest second Gaussian sigma value.

19. The method for manufacturing the semiconductor device of claim 10,
wherein forming the optical proximity correction model includes, before optimizing the optical proximity correction model:
acquiring a SEM image, which is an average image of a plurality of images obtained by taking images of the photoresist pattern, and a GDS image, which is an image of the layout;
aligning the SEM image and the GDS image with each other;
performing image filtering on the SEM image; and
extracting a contour from the SEM image,
wherein optimizing the optical proximity correction model is performed by verifying the contour.

20. A computing system comprising:
a processor; and
a memory which stores instructions,
wherein when executed by the processor, the instructions cause the processor to perform operations comprising, by using a genetic algorithm:
preparing candidate chromosomes representing candidate solutions, wherein each of the candidate chromosomes includes a plurality of genes;
classifying the candidate chromosomes into a plurality of population groups each of which follows a Gaussian distribution;
calculating a fitness value for each of the candidate chromosomes;
generating a rank value on the basis of the calculated fitness value;
determining whether a genetic algorithm ends on the calculated fitness value;
selecting a parent chromosome among the candidate chromosomes when the genetic algorithm does not end;
generating offspring chromosomes from the parent chromosome, in which the genes of the offspring chromosomes follow a Gaussian distribution of a population group to which the parent chromosome belongs;
determining whether the fitness value change is saturated;
adjusting a configuration of the plurality of population groups when the fitness value change is saturated; and
classifying the generated offspring chromosomes into the plurality of population groups.
